(19) United States
(12) Patent Application Publication
(10) Pub. No.: US 2014/0095421 A1
(43) Pub. Date: Apr. 3, 2014

(54) Predicting Viewable Events

(71) Applicant: Timothy Romanowski, Corvallis, OR (US)

(72) Inventor: Timothy Romanowski, Corvallis, OR (US)

(21) Appl. No.: 13/633,589

(22) Filed: Oct. 2, 2012

(51) Int. Cl. G06N 5/02

(52) U.S. Cl. 706/46

(57) ABSTRACT

Embodiments are disclosed to provide the prediction of viewable events. Predicting viewable events will allow users to know what events will likely be viewable in a particular venue, such as a restaurant, bar, or private home. Information about venues and events is populated in a database by a plurality of venues or users. Users wishing to view a particular event can search for a venue that has a high probability of showing that event.

### BACKGROUND OF THE INVENTION

1. Field of the Invention

The present invention relates to a method for determining venue-specific viewable events, and more specifically, to predicting viewable events displayed at a particular venue.

2. Description of the Related Art

It is well known within the related art that crowdsourcing is hugely successful in problem-solving tasks. Much like scientific research committees or focus groups, crowdsourcing is an activity in which an individual, an institution, a non-profit organization, or company proposes to a group of individuals of varying knowledge, heterogeneity, and number, via a flexible open call, the voluntary undertaking of a task.

The undertaking of the task, of variable complexity and modularity, and in which the crowd should participate bringing their work, money, knowledge and/or experience, always entails mutual benefit. The user will receive the satisfaction of a given type of need, be it economic, social recognition, self-esteem, or the development of individual skills, while the crowdsourcer will obtain and utilize to their advantage that what the user has brought to the venture, whose form will depend on the type of activity undertaken.

Within the related art, the advent of the Internet enhanced the ease at which crowdsourcing could be performed, and became a preferred method for distributing tasks or calling upon voluntary user input for completing said tasks. Crowdsourcing has revolutionized how music reaches listeners by enabling Pandora Internet Radio enthusiasts to collaboratively group and categorize music into genres and like-artist specific channels. The Galaxy Zoo Project has allowed amateur astrologists to classify over 50 million galaxies photographed in the Sloan Digital Sky Survey. The Internet encyclopedia, Wikipedia, relies predominantly on non-profit crowdsourcing to create, update, and maintain over 23 million pages of information.

Further enhancing distribution and collection of data, mobile devices allowed figures and data to be submitted from virtually anywhere a signal could be had. These devices untethered users from their home computers and allowed for situational and location-based inputs. Those being crowdsourced could report, without any delay, to the crowdsourcer, and as such, accuracy increased dramatically. As a side effect of this promptness, the type of distribution-based problems could evolve towards those based on real-time, present scenarios.

At present, implicit crowdsourcing and explicit crowdsourcing provide two separate avenues of obtaining and using sourced information. As a result of the increasing speeds at which data can be obtained, it could be said that this results in a need of an intermediate between the two whereas a user can input their own evaluations of an entity, while simultaneously; a database is implemented and immediately modified to alter a proposed output based upon the initial users input.

The immediate input, output, and retrieval of data to mobile devices is not a new to the art. Weather applications use input from mobile users and stations to establish current, accurate, location-based weather conditions that are easily accessed via mobile applications. Many car enthusiasts use mobile applications to report and compile known locations of traffic enforcement officers or speed traps.

Unfortunately, within the related art, there exists no method for predicting whether or not a specific event will be televised at any plurality of venues, such as, but not limited to, a pub, bar, or restaurant. The present invention meets this need by allowing users to report the location of a specific event televised at the venue, and to issue it to a database of known events.

Database-compiled predictions based upon previous events are well known within the related art.

Financial institutions may use this compilation method in the prediction and risk-assessment values of stock pricing or inflation rates. Using known parameters coupled with end-user-provided inputs to assign a Boolean Value to any specific entity or event can be vastly beneficial. Currently, companies such as Nielsen publish ratings after a show has been shown on TV. The ratings are based on actual viewings of the show based on input from set-top boxes or other electronic devices. These ratings can be used for predicting whether or not a future program will succeed in attracting revenue from advertisers.

The present invention enables users to report the location of a specific event from the venue, and issue it to a database of known events. This information is received, interpreted by the present invention, and then is made available for reference by a user as a way of predicting which venue would be more likely to televise a particular sporting event.

### BRIEF SUMMARY OF THE INVENTION

Embodiments are disclosed to provide the prediction of viewable events. Predicting viewable events can be used to determine the probability of an event being displayed in a particular venue, such as a restaurant, bar, or private home. Users wishing to view a particular event will be able to find a venue that has a high probability of displaying the event.

In a preferred embodiment of the present invention, a venue could enter viewable event information into a computer database. The information may contain whether the venue will display an event, whether the venue has the ability to display an event, the number of times a similar event has been displayed in the past, or other data.

In another preferred embodiment of the present invention, a user may launch a mobile application on a portable computing device. The mobile application may communicate with a database that allows the user to enter venue or viewable event information. The user may enter information about a viewable event that was previously displayed at a particular venue. A prediction engine may use the viewable event information to calculate the probability that the venue will display an upcoming viewable event. Some of the information that the prediction engine may include, but is not limited to, how many users have checked in at the venue, how the venue is rated by users for a team participating in the event, and how many times the venue has shown similar events.

The preceding embodiments are intended to be exemplary in nature and are not intended to be limiting. It is possible that those skilled in the art will see further embodiments of the present invention. Other objects and advantages of the present invention will be more fully apparent from the following disclosure.

### BRIEF DESCRIPTION OF THE SEVERAL VIEWS OF THE DRAWING(S)

FIG. 1 is a flowchart for predicting viewable events using venue generated information as according to one embodiment of the present invention;

FIG. 2 is a flowchart for predicting viewable events using user generated information as according to one embodiment of the present invention;

FIG. 3 is a schematic block diagram of a client, prediction engine relationship for predicting viewable events as according to one embodiment of the present invention;

FIG. 4 is an exemplary window showing a check-in feature for predicting viewable events as according to one embodiment of the present invention; and

FIG. 5 is a schematic diagram of an exemplary viewable event prediction system as according to one embodiment of the present invention.

A further understanding of the present invention can be obtained by reference to preferred embodiments set forth in the illustrations of the accompanying drawings. Although the illustrated embodiments are merely exemplary for carrying out the present invention, both the organization and methods of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

In a manner described below, the data processing aspects of the present invention may be implemented, in part, by programs that are executed by a computer. The term “computer” as used herein includes any device that electronically executes one or more programs, such as personal computers (PCs), hand-held devices, multi-processor systems, microprocessor-based programmable consumer electronics, network PCs, minicomputers, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing environments, where tasks are performed by remote processing devices that are linked through a communications network. In a distributed computing environment, programs may be located in both local and remote memory storage devices.

Referring now to the present invention, there is described exemplary embodiments for predicting viewable events. For the purpose of clarity, the terms “predicting viewable events”, “prediction”, “present invention”, and “invention” may be used interchangeably to refer to the afore-mentioned predicting viewable events invention.

Several preferred embodiments for predicting viewable events are discussed in this section. However, the invention is not limited to these embodiments. The present invention includes any form of predicting viewable events that provides a probability of a venue displaying an event. The prediction techniques are not limited in terms of number or type of venues or users, information used to generate the prediction, communication method, event type, or venue.

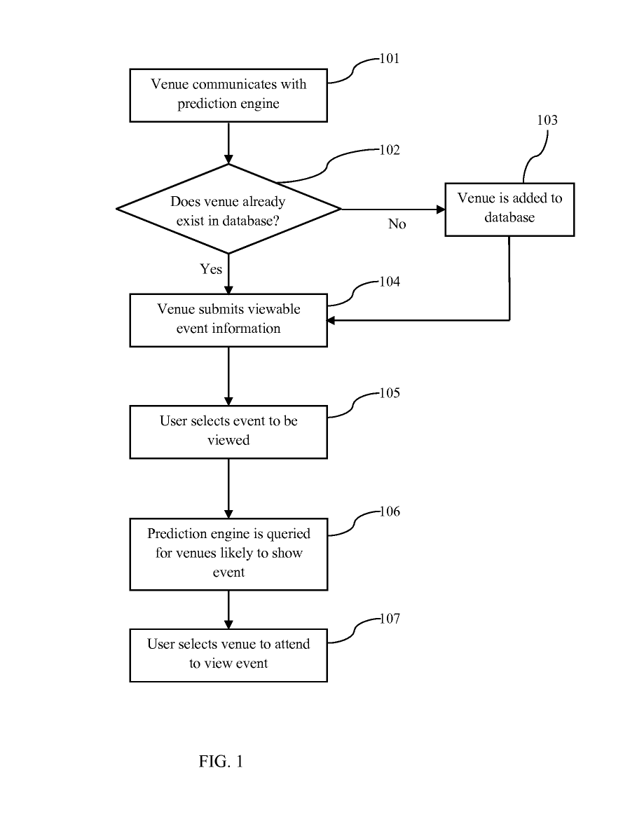

Referring now to FIG. 1, there is shown a flowchart for predicting viewable events using venue generated information as according to one embodiment of the present invention. A venue may communicate with a prediction engine (101) so that the venue could enter information into a database. If the venue does not exist in the database, the venue may create a new entry in the database (103). Adding the venue to the database may include, but not be limited to adding information about the venue such as address, hours of operation, number of viewing devices, how many viewable events the venue can display, whether the venue requires users to pay to view the event, whether the venue has the proper subscriptions to display the event, how many times the venue has displayed similar events, menu selections, type of establishment, or any other information requested by a viewable events prediction engine. If information about the venue is already in the database, or the venue has added its information to the database (103), the venue may submit viewable event information to the database (104). Viewable event information may include the type of event, such as whether it is a sporting event, a news event, an entertainment event; the teams or participants in the event; the duration of the event; a rating for the event; or any other information requested by a prediction engine.

A user may select an event that he or she wishes to view (105). The user could search for a venue that has a high probability of displaying that event. When looking for a venue that has a high probability of displaying the event, a prediction engine may be queried for venues that are likely to show the event (106). The prediction engine may use information stored in the database to generate the prediction. Once the prediction engine has been queried for venues likely to show the event (106), the user may be provided with a list of venues that are displaying the event along with a probability indicator that indicates the probability of each venue showing the event. The user may then select a venue to attend to view the event (107).

The prediction of viewable events steps presented in FIG. 1 may be performed by way of an application or a computer program. A cell phone, tablet computing device, laptop, or desktop, or any combination thereof may be used by the venue or by the user when performing the aforementioned steps.

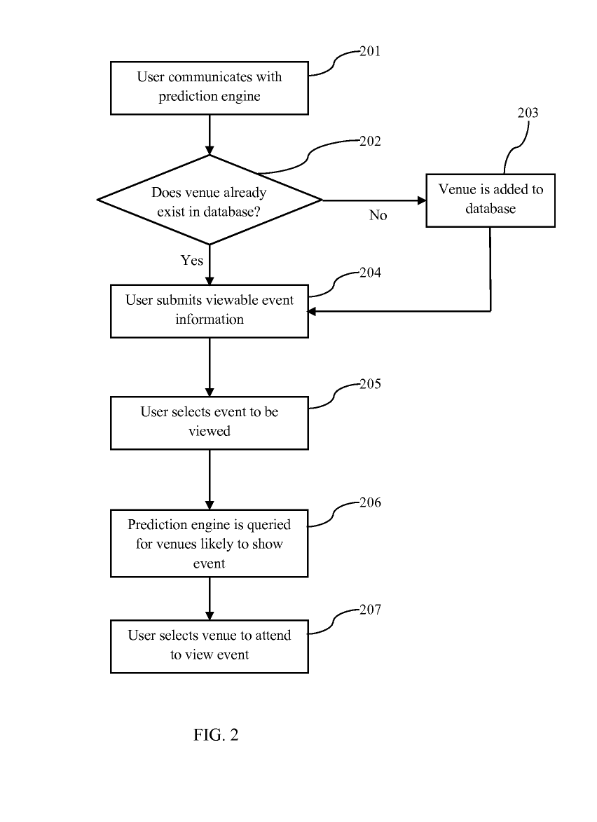

Referring now to FIG. 2, there is shown a flowchart for predicting viewable events using user generated information as according to one embodiment of the present invention. A user may communicate with a prediction engine (201) so that the user could enter information about a venue into a database. If the venue does not exist in the database, the venue may create a new entry in the database (203). Adding the venue to the database (203) may include, but not be limited to adding information about the venue such as address, hours of operation, number of viewing devices, how many viewable events the venue can display, whether the venue requires users to pay to view the event, whether the venue has the proper subscriptions to display the event, how many times the venue has displayed similar events, menu selections, type of establishment, or any other information requested by a viewable events prediction engine. If information about the venue is already in the database, or the user has added venue information to the database (203), the user may submit viewable event information into the database (204). Viewable event information may include the type of event, such as whether it is a sporting event, a news event, an entertainment event; the teams or participants in the event; the duration of the event; a rating for the event; or any other information requested by a prediction engine.

A user may select an event that he or she wishes to view (205). The user could search for a venue that has a high probability of displaying that event. When looking for a venue that has a high probability of displaying the event, a prediction engine may be queried for venues that are likely to show the event (206). The prediction engine may use information stored in the database to generate the prediction. Once the prediction engine has been queried for venues likely to show the event (206), the user may be provided with a list of venues that are displaying the event along with a probability indicator that indicates the probability of each venue showing the event. The user may then select a venue to attend to view the event (207).

The prediction of viewable events steps presented in FIG. 2 may be performed by way of an application or a computer program. A cell phone, tablet computing device, laptop, or desktop, or any combination thereof may be used by the user when performing the aforementioned steps.

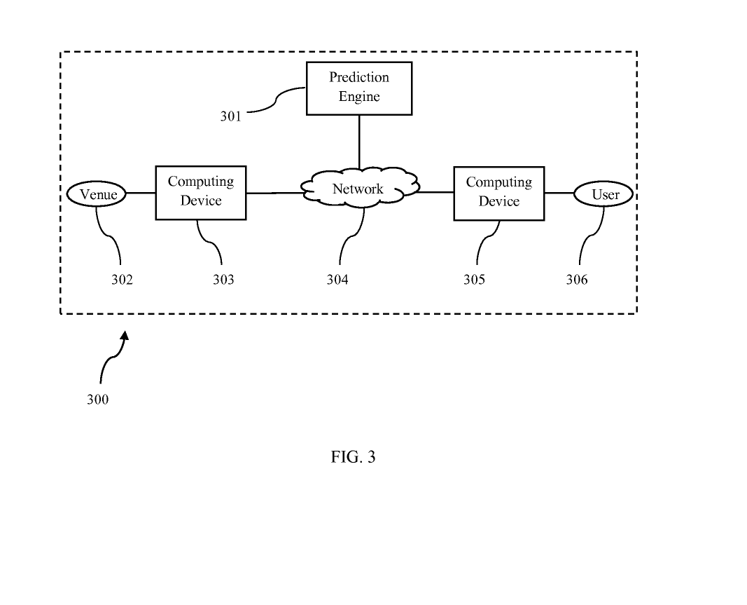

Referring now to FIG. 3, there is shown a schematic block diagram of a client, prediction engine relationship for predicting viewable events (300) as according to one embodiment of the present invention. A venue (302) may use a computing device (303) to communicate through a network (304) with a prediction engine (301). The venue (302) may communicate with the prediction engine (301) for the purposes of uploading venue information so that the prediction engine (301) will be able to better predict whether the venue (302) will display a particular event. A user (306) may use a computing device (305) to communicate through a network (304) with a prediction engine (301). The user (306) may communicate with the prediction engine (301) for the purposes of uploading venue information so that the prediction engine (301) will be able to better predict whether the venue (302) will display a particular event. The user (306) may also communicate with the prediction engine (301) to locate venues (302) that have a high probability of displaying a viewable event that the user (306) wishes to view. It should be noted that the venue (302) or the user (306) may communicate with the prediction engine (301) to perform any of the predicting viewable events steps set forth in FIGS. 1 and 2.

The computing devices (303, 305) may include any computational device such as laptops, palm devices, desktops, mobile devices, cellular telephones, tablets, smartphones, media storage devices, or any other device capable of performing prediction functions. The computing devices (303, 305) may connect to a network (304). Connections to the network (304) may occur by way of wireless or wired communications. Wireless communications may include WiFi, cellular communications, or any other wireless communication protocols. The computing devices (303, 305) may access the prediction engine (301) through the network (304) in order to transmit or receive information. The prediction engine (301) may include a database that is a computer-implemented repository that contains venue information, viewable event information, or user information. Venues (302) or users (306) may access information from the prediction engine (301) or retrieve information from the prediction engine (301) in order to retrieve the probability of venues (302) displaying viewable events; to upload venue (302), viewable event or user (306) information; or to retrieve venue (302) or viewable event information. User information may include such information as user (306) check-ins, and the events that users (306) viewed at a venue (302).

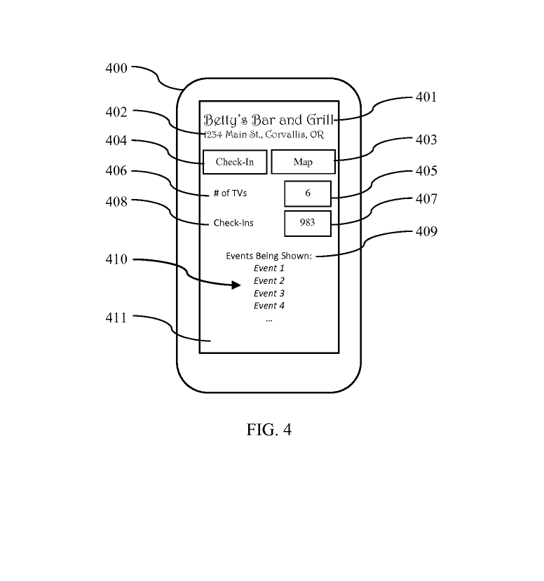

Referring now to FIG. 4, there is shown an exemplary window (411) with a check-in feature for predicting viewable events as according to one embodiment of the present invention. The window (411) may be contained within an application developed for predicting viewable events. A portable device such as a smartphone or tablet (400) may be used to execute the application. The window (411) may contain features that allow a user to predict whether a venue will display a viewable event. The features may include the name of a venue (401), the address of a venue (402), a check-in button (404) for checking-in at a particular venue, a map access button (403) that may retrieve a map showing the location of the venue, a number of TVs field (406) that displays the number of televisions (405) at the venue, a check-in field (408) that displays the number of check-ins (407) at a venue, and a viewable events field (409) that lists one or more viewable events (410) being shown at the venue. A user may access the window (411) within the application when the user wishes to enter information about an event or venue, or when the user wishes to retrieve information about an event or venue.

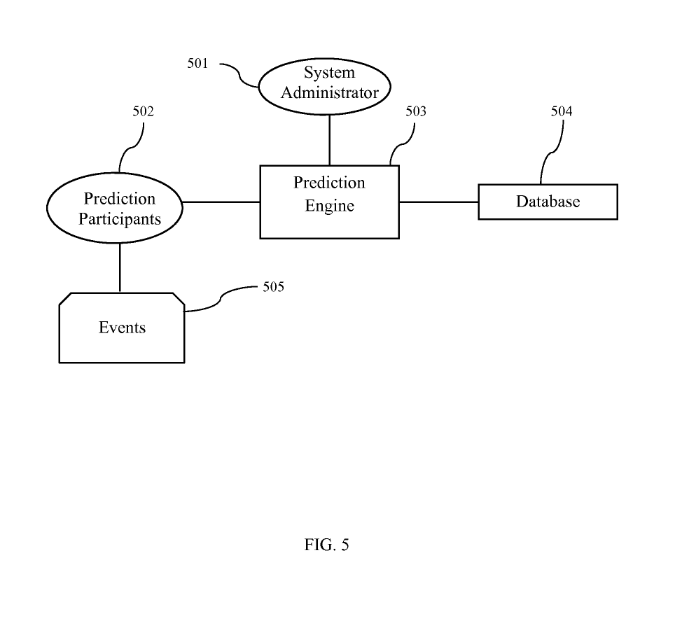

Referring now to FIG. 5, there is shown a schematic diagram of an exemplary viewable event prediction system as according to one embodiment of the present invention. The viewable event prediction system may include a system administrator (501) that could maintain system integrity, manage the viewable event prediction system, set permissions, add or remove information from the system, or perform any other function of a system administrator. Viewable event prediction participants (502) may be venues or users that participate in the viewable event prediction system by transmitting or accessing information in a database (504) that is controlled by a prediction engine (503). The information may include, but not be limited to, adding information about the venue such as address, hours of operation, number of viewing devices, how many viewable events the venue can display, whether the venue requires users to pay to view the event, whether the venue has the proper subscriptions to display the event, how many times the venue has displayed similar events, menu selections, type of establishment, or any other information requested by a viewable events prediction engine (503). The information may also include information about a viewable event (505) such as whether it is a sporting event, a news event, an entertainment event; the teams or participants in the event; the duration of the event; a rating for the event; or any other information requested by a prediction engine (503). The information may be used by the viewable event prediction participants (502) to let other viewable event prediction participants (502) know the probability that a venue (502) will display a viewable event (505), or to find venues (502) with a high probability of displaying a desired viewable event (505). The prediction engine (503) may contain the logic that operates the viewable event prediction system. One logic component may assimilate information from the viewable event prediction participants (502) and associate venues (502) with viewable events (505). Another logic component may be a gateway that controls information received from, or transmitted to, viewable event prediction participants (502). Yet another logic component may generate a viewable event probability indicator from a plurality of information in the database (504).

It should be noted that the example software and/or firmware implementations described herein may be optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain exemplary embodiments for predicting viewable events have been described herein, the scope of coverage of this patent is not limited thereto. On the contrary, this patent covers all embodiments for predicting viewable events fairly falling within the scope of the invention either literally or under the doctrine of equivalents.

With respect to the above description then, it is to be realized that the optimum configuration and relationships for the elements for predicting viewable events are deemed readily apparent and obvious to one skilled in the art, and all equivalent relationships to those illustrated in the images and described in the specification are intended to be encompassed by the present invention.

Therefore, the foregoing is considered as illustrative only of the principles for predicting viewable events. Further, since numerous modifications and changes will readily occur to those skilled in the art, it is not desired to limit the center to the exact construction and operation shown and described, and accordingly, all suitable modifications and equivalents may be resorted to, falling within the scope for predicting viewable events. While the above description describes various embodiments of the present invention, it will be clear that the present invention may be otherwise easily adapted to satisfy any requirements for predicting viewable events.

As various changes could be made in the above configuration or organization without departing from the scope of the invention, it is intended that all matter contained in the above description or shown in the accompanying images shall be interpreted as illustrative and not in a limiting sense.

What is claimed is:

1. A method comprising:
storing information, wherein the information consists of information about one or more venues and information about one or more viewable events, determining a probability that a venue will display an event, distributing the probability to one or more users.

2. The method of claim 1, wherein the information about one or more venues further comprises the name of the venue.

3. The method of claim 1, wherein the information about one or more viewable events further comprises the type of the viewable event.

4. The method of claim 1, wherein the users access the probability by using a computing device.

5. The method of claim 4, wherein the computing device contains an application that allows the users to access the probability.

6. The method of claim 1, wherein the information about one or more venues is entered into a prediction engine by the venue or by the users.

7. The method of claim 1, wherein the information about one or more viewable events is entered into a prediction engine by the venue or by the users.

8. The method of claim 1, wherein the probability allows users to find a venue that is likely to display a viewable event.

9. A system for predicting viewable events comprising:
a prediction engine that generates a probability, one or more databases configured to store information about a plurality of venues and a plurality of viewable events, and an application that allows a user to retrieve the probability from the prediction engine to determine the likelihood a venue will display a viewable event.

10. The system of claim 9, wherein the information about a plurality of viewable events includes information about the type of viewable events.

11. The system of claim 9, wherein the information about a plurality of venues includes the name of the venue.

12. The system of claim 9, wherein the application is executed on a computing device.

13. The system of claim 9, wherein the application further comprises a check-in function.

14. The system of claim 9, wherein the information in the one or more databases is populated by one or more users or venues.

15. A method for predicting viewable events comprising:
receiving viewable event information, receiving venue information, generating a prediction that a venue will display a viewable event, transmitting the prediction to a user.

16. The method of claim 15, wherein the viewable event information includes the type of the event.

17. The method of claim 15, wherein the venue information includes the name of the venue.

18. The method of claim 15, wherein the prediction is a probability of whether a venue will display a viewable event.

19. The method of claim 15, wherein the viewable event information and the venue information is stored in one or more databases.

20. The method of claim 15, wherein the user uses a computer application to receive the prediction.
